(19) United States
(12) Patent Application Publication
(10) Pub. No.: US 2023/0251631 A1
(43) Pub. Date: Aug. 10, 2023

(54) A METHOD FOR MANUFACTURING CONSTRUCTION COMPONENTS, A PORTABLE MANUFACTURING UNIT, A SOFTWARE APPLICATION EXECUTABLE ON A MACHINE TOOL SYSTEM FOR CONTROLLING A TOOL, THE MACHINE TOOL SYSTEM, AND A METHOD OF MACHINING THE WORKPIECE USING THE TOOL

(71) Applicant: ODICO A/S, Odense (DK)

(72) Inventors: Jens Pedersen, Odense (DK); Asbjørn Søndergaard, Odense (DK); Anders Petersen, Odense (DK); Narendrakrishnan Neythalath, Odense (DK)

(21) Appl. No.: 18/010,337

(22) PCT Filed: Jun. 15, 2021
(86) PCT No.: PCT/EP2021/066082

§ 371 Date: Dec. 14, 2022

(30) Foreign Application Priority Data
Jun. 15, 2020 (EP) 20180041.4

(51) Int. Cl. G05B 19/4155

(52) U.S. Cl. CPC G05B 19/4155; G05B 2219/35519

(57) ABSTRACT

A software application executable on a machine tool system for machining a workpiece is configured for executing the steps of: instructing an image recording device to capture an image of a first workpiece having one or more hand-drawn notations, associating the one or more notations with at least one machining step of the machine tool system, presenting on a display device the at least one machining step of the machine tool system on or in relation to the captured image, and/or the first workpiece as the first workpiece will appear after machining the first workpiece according to the at least one machining step of the machine tool system, and optionally controlling a tool of the machine tool system for machining the first workpiece according to the one or more notations.

### CROSS-REFERENCE TO RELATED APPLICATIONS

This application is the U.S. National Stage of PCT/EP2021/066082 filed on Jun. 15, 2021, which claims priority to European Patent Application 20180041.4 filed on Jun. 15, 2020, the entire content of both are incorporated herein by reference in their entirety.

### FIELD OF THE INVENTION

The invention relates to a method for manufacturing construction components at a building site, a portable manufacturing unit for manufacturing construction components, a software application executable on a machine tool system for controlling a tool for machining a workpiece, to a machine tool system configured to be controlled by the software application for machining a workpiece, and a method of machining a workpiece using the tool of the machine tool system.

### BACKGROUND OF THE INVENTION

Currently, partially automated processes exist for machining of certain construction materials, including timber. However, the mechanical steps and workflow design applied in such facilities are all assuming factory-size installations with no limitations on spatial requirements. Further, these processes are driven by standard file-to-factory workflows, which means a fixed design is given, and then repeatedly produced. Therefore, these technologies are suited to mass-produce prefabricated components. By contrast, a majority of for instance timber construction is executed by Small-Medium Enterprises (SME's) as on-site, project specific labor. Here, adaption to the specific site and project is key; as well as iterative measurements and correction to the ongoing construction work. Therefore, manual on-site labor constitutes the vast majority of construction works —even if automated procedures are generally more effective, they are not capable of performing sufficiently flexibility.

When working on a construction site, the building elements used come in standard sizes that have to be adapted to fit. The building elements can e.g. be wooden or gypsum boards used for house building, or concrete slabs for a pavement or in front of a house. To be able to machine the elements to fit, correct measurements and markings on the elements are necessary, and afterwards the elements have to be machined accurately according to the markings. If a fault is made in any of the steps of measuring, marking and machining the element will not fit, and another element has to be measured, marked and machined, which will cost time and money. A faster and more reliable procedure would be very helpful and appreciated.

Stationary, computer-controlled systems for digital production of timber elements are a well-established part of the timber pre-fabrication industry. But they are time-consuming to program and complicated to operate. This means that they require well-educated users in the form of CAM-specialists; and that because of the programming time required to instruct the system in machining a part, they are only useful for complicated parts or larger series production.

By contrast, carpenters working on-site typically are trained only in manual execution and are not experienced in using such systems. Further, many types of on-site construction work—such as for instance house renovations—typically requires many in-situ measurements and adaptions. Therefore, the complexity and time-consumption to program a digital production system to execute such parts by far outweigh the speed and directness of manual execution, thus rendering the use of such system practically infeasible for such tasks.

Augmented reality is a computer technology for viewing partially synthetic environments. Augmented reality can be used to refer to various types of computer assisted representations of the real world. In particular, augmented reality displays sometimes use a photograph or video of a real world environment such as, for example, a photograph or video of an environment around a smartphone as captured by a camera or other display device associated with the smartphone. These images can be supplemented with computer generated information such as tags, flags, or the like, which can be used to denote places of interest or other information within the images. The supplemented information can be provided, in some embodiments, as an image overlay that provides information about objects viewable in the image.

### SUMMARY OF THE INVENTION

Considering the prior art described above,

It is an object of the present invention to present a production workflow that will reduce the construction time at a building construction or rebuilding site.

It is another object of the present invention to present a fully automatic manufacturing unit for manufacturing construction components, where the manufacturing unit can easily be transported from construction site to construction site.

It is another object of the present invention to reduce the complexity of instruction for telling the software application executable on the machine tool system how to machine a workpiece, to reduce the time for instructing the software application how to machine an element and to reduce the number of wrongly machined elements.

The object can be achieved by means of a software application as disclosed herein.

By proposing a method that uniquely allow for miniaturization of automated production workflows to a degree that they can fit into a portable unit—a small scale cargo or box trailer or shipping container—while still being able to process large scale raw materials in dimensions normative to current construction practice.

This is uniquely achieved by utilizing the versatility of an industrial manipulator to pick single pieces of raw material from a stack; and place this in an external axis. By utilizing the external axis to translate the material along one or more directions, the material can be processed across its entire area from the manipulator in a fixed position inside a small space. This allow for the unique utility value of easily transporting a manufacturing unit to a construction site; feed it a stack of raw materials; and let the manufacturing unit process the entire stack in an unsupervised fashion to unique dimension, ready for manual assembly into a final structure.

By external axis is understood a device, which clamps cylindrical rollers around a given material, and by rotating the rollers are capable of translating the piece on top of the external axis back and forth. By working in synchronization with the manipulator, the material can hereby be positioned at desired lengths to be cut to measure at predefined cutting zones. That the cylindrical rollers clamp the piece on top of the external axis means that the piece can be moved at a high speed in a controlled fashion.

The external axis can in addition or alternatively be understood to mean a surface with rollers or a conveyor belt or conveyor chain, or another carrying medium, that is able to move the transferred piece on top of the external axis to and fro in one direction.

In addition to allowing for transportability, the method enables manufacturing within a closed envelope, which is key to achieve the highest levels of work safety with the smallest amount of effort.

The transportable frame can be understood as a load platform on which the industrial manipulator and the external axis are situated and the bed can be situated.

The method for manufacturing construction components can comprise the step of transporting the transportable frame to the building site method for manufacturing construction components at the building site. The transportable frame can be a trailer to be pulled by a vehicle like a truck, a light truck, or a car or the transportable frame can be a rear part of a truck, e.g. on top of a load platform, so that the transportable frame can easily, in no time, by a single person, and with few man-hours be transported to a new building site.

In an embodiment, the material stack can comprise uni-directionally elongated pieces, such as boards, beams, pipes or rods.

The above method is uniquely advantageous for uni-directionally elongated semi-manufactures like boards, beams, rods or pipes, as their large dimensions in one direction make them difficult to process within a small footprint.

In an embodiment, the transportable frame can comprise a cover, wherein the material stack or the piece of the material stack is loadable/transferrable through an opening in the cover.

The cover can protect at least the manipulator from the exposure to the weather, increasing the lifetime of the manipulator. The cover can be made of a hard material that is difficult to break through like PVC or plastic or PVS or plastic that is strengthened by e.g. integrated metal rods or an integrated metal net, for protecting at least the manipulator from being stolen. Preferably, the cover covers the whole transportable frame.

By creating a full enclosure or cover with one or more coverable openings for intake of material, instead of e.g. unfolding one side entirely, it is guaranteed that the dangerous machining processes remain encapsulate for increased operator safety.

In an embodiment, the cover can comprise a longer side and a shorter side and the opening stretches along the longer side.

By ensuring the enclosure has a directionality in its footprint, it can be made compatible with dimensions for road transport, which typically impose strict limitations on the width and height of the transportable unit. Having the feed opening positioned at the longitudinal side of this arrangement allow for one-directionally elongated elements of considerable length to be easily loaded via forklift, as opposed to loading from the lateral and shorter side, which would entail much greater effort. This greater effort would include the operational difficulty of sideways loading with a forklift; or requiring extendable supports on which to roll in the materials. Loading from the lateral and shorter side is plausible within the context of this disclosure but not preferred.

If the cover is made of a hard material, the longer side cover can preferably be hinged at the upper end so that the manipulator and/or the external axis and/or the bed can be easily exposed by a single person, and still encapsulating most of the machining processes for increased operator safety.

At least a lower part of the shorter side or preferably of the longer side can be of a hard material and hinged at the lower end of the lower part, so that the lower part when opened up forms an extension of the transportable frame outside the cover. By fastening the external axis on the lower part, long pieces of the loaded material stack can be moved by the external axis without the size limitations due to the cover.

In an embodiment, the manipulator can change manipulation heads between the steps of transferring the piece onto the external axis and of manufacturing the transferred piece, the manipulator can comprise simultaneously the manipulation heads for transferring the piece onto the external axis and for manufacturing the transferred piece, or the manipulator for transferring the piece onto the external axis and the manipulator for manufacturing the transferred piece can be two different manipulator.

By facilitating a synchronized alternation between respectively a) gripping and positioning operations to place the material at a desired spatial location, and b) utilizing this location to cut or machine the material to desired targets, a mechanical versatility is achieved for producing a vast plurality of designs with a simple mechanism design.

In an embodiment, the method can comprise the step of receiving data about final length of at least one of the manufactured construction components and/or angle of machining.

By digitally controlling the above system such that target lengths and angles of components can be machined from a raw material, the invention achieves the important utility of manufacturing variable target designs from a stack of standardized raw materials.

In an embodiment, length and/or width and/or thickness of the piece to be manufactured and/or of the manufactured construction component can be determined.

By automatically or through user input determining the dimensions of the input raw materials, the disclosure acquires the critical utility of being capable of handling a plurality of input materials, which greatly increases its versatility.

In an embodiment, the manipulator and/or the external axis can be controlled by a mobile computing device.

By enabling control of the invention through a mobile device, a very high degree of user flexibility is achieved, in that conventional manufacturing systems require expert knowledge of operations; whereas interfaces offered in mobile computing is perceived as broadly accessible. In addition, the wireless connection implied by control through mobile computing devices offers the unique utility for the user to bring the device into sites that are difficult to reach, to take custom measures and record these directly on the device for immediate transmission to the manufacturing unit.

In an embodiment, each component in a series of manufactured construction components can be at least partly uniquely labelled.

By facilitating digital labelling of individually machined components, the invention acquires the advantageous utility of marking components with identifiers with respect to a later assembly process, which greatly increases the efficiency of said assembly process. The user will know how to assemble the construction component and/or in which order to assemble them or attached together or on a wall. Much time will be saved.

The invention also relates to a portable manufacturing unit for manufacturing construction components, the manufacturing unit comprising a bed for receiving a material stack (elongated) to be manufactured, an external axis, an industrial manipulator configured for transferring a piece of the material stack to the external axis, wherein the external axis is configured for moving the transferred piece on top of the external axis for allowing a desired position of the piece to be manufactured by the manipulator, wherein the manipulator is further configured for manufacturing the moved piece into a manufactured construction component, and wherein the external axis or the manipulator is configured for transferring the manufactured construction component to a second stack of manufactured components.

The portable manufacturing unit can comprise a portable carrier or the transportable frame, which preferably has wheels so that it is easy to move around the portable manufacturing unit. The portable carrier or the transportable frame can be a trailer to be pulled by a vehicle like a truck, a light truck, or a car or the portable carrier or the transportable frame can be a rear part of a truck, e.g. on top of a load platform of the truck or light truck.

The carrier can be a transportable frame carrying an industrial manipulator and an external axis.

In an embodiment, the manufacturing unit can have a longer side and a shorter side, and the manufacturing unit can comprise a cover covering the manufacturing unit, wherein the cover can have a first opening along the longer side configured for receiving the material stack and/or the piece of the material stack.

For the portable manufacturing unit to be able to manufacture as long manufactured construction components as possible, the external axis is preferably positioned for moving the transferred piece on top of the external axis parallel to the longer side.

In an embodiment, the manufacturing unit can have a longer side and a shorter side, and the manufacturing unit can comprise a cover covering the manufacturing unit, wherein the cover can have a second opening in the shorter side, wherein the second opening can be positioned for allowing at least an end of the transferred piece on top of the external axis to be moved past the cover.

The second opening allows for the transferred piece on top of the external axis to be as long as the longer side and still be moved by the external axis, since the end of the transferred piece will go through the second opening.

If the opening and the second opening together forms one single opening then the portable manufacturing unit can easily receive the transferred piece even when the transferred piece is longer than the transportable frame of the carrier.

If there is a second side opposite the shorter side, the second side can have a third opening, wherein the third opening can be positioned for allowing at least the other end of the transferred piece on top of the external axis to be moved past the cover on the second side. With both the second opening and the third opening the transferred piece can be moved freely by the external axis.

A single piece to be manufactured can be loaded directly on the external axis through the second opening or the third opening.

In an embodiment, the manipulator can change manipulation heads between the steps of transferring the piece onto the external axis and of manufacturing the transferred piece, the manipulator comprises simultaneously the manipulation heads for transferring the piece onto the external axis and for manufacturing the transferred piece, or the manipulator for transferring the piece onto the external axis and the manipulator for manufacturing the transferred piece are two different manipulator.

The industrial manipulator can be alternateable between a gripping device for moving or positioning material and a sawing or milling spindle for material machining. That makes a very adaptable instrument.

In an embodiment, the portable manufacturing unit can be controlled by a mobile computing device, which can easily be carried by the user.

The mobile computing device can be a smartphone or a tablet computer or a computer. The user can easily provide the size and/or shape of the finished construction components.

In an embodiment, the portable manufacturing unit can comprise a sensor configured for determining length and/or width and/or thickness of the piece to be manufactured and/or of the manufactured construction component.

The sensor can be a laser rangefinder for determining the length or the width or the thickness of the piece to be manufactured or of the manufactured construction component. The sensor can be a camera with a software for analysing angles of the piece to be manufactured or of the manufactured construction component.

In an embodiment, the portable manufacturing unit can comprise a labelling machine configured for labelling the manufactured construction components at least partly uniquely.

The labelling machine apply one unique label, like a number or a letter or a certain sign, to each manufactured component, so that all manufactured components having the same dimensions are given the same label, while manufactured components having another dimension are given another label. The label can e.g. be made of ink or an indentation in the manufactured component. If e.g. a wall is to be covered by manufactured components in the form of e.g. boards the first manufactured component to be attached to the wall, e.g. the manufactured component to be attached to the far right of the wall is labelled e.g. an “1” or an “A” and the manufactured component to be attached next to the manufactured component labelled “1” or “A” is labelled “2” or “B”, etc. A carpenter will not need to spend time how to arrange the boards, which will save time.

The invention also relates to a software application executable on a machine tool system for machining a workpiece, wherein the software application is configured for executing the steps of: instructing an image recording device to capture an image of a first workpiece having one or more hand-drawn notations, associating the one or more notations with at least one machining step of the machine tool system, presenting on a display device the at least one machining step of the machine tool system on or in relation to the captured image, and/or the first workpiece as the first workpiece will appear after machining the first workpiece according to the at least one machining step of the machine tool system, and optionally controlling a tool of the machine tool system for machining the first workpiece according to the one or more notations.

The software application cannot do anything by itself, but only when executed on the machine tool system having the tools necessary to perform the machining step. When the software application is said to be able/adapted/configured to something, the software application is able/adapted/configured to that something when executed on the machine tool system.

Even though the expression the machine tool system is used the expression can also mean the software application executable on a machine tool system for machining a workpiece.

By drawing a handwritten sign using the type of sign normally used by a carpenter and using the software application according to the present invention executed on a machine tool system, a person without any knowledge of robotics can utilize all the benefits of a robotic system.

The present invention is also very fast and accurate, since the machine tool system and the software application executable on a machine tool system are easily instructed by the normal type of hand-drawn notations used by carpenters. When cutting a workpiece by a saw, a straight or curved line, a sign or a combination of straight and/or curved lines and/or signs and/or numbers, which according to the present disclosure can be one or more notations, is/are drawn by hand to be followed by cutting by the saw. However, according to the present invention, the cutting procedure is left to the software application executable on the machine tool system.

Rectangular stone slabs to be machined so the machined slabs can form e.g. a circle or follow shape of a rounded pavement corner only need a slightly pointed shape. The correct line is easily drawn but a straight, even cut is more complicated. To find the right angle on any cutting machine when the angle is just a few degrees is difficult. The software application executable on a machine tool system will be a very good help and assistance.

By associating the one or more notations with at least one machining step of the machine tool system, the software application connects the one or more hand-drawn notations with one or more machining steps. The software application preferably has access on a local disc or a memory card and/or in the clouds by an Internet connection to a library connecting different hand-drawn notations with specific machining steps. Preferably, the library comprises for each machine step hand-drawn notations drawn by a huge number of different persons, so that the software application is able to correctly distinguish one hand-drawn notation connected to one machining step from another hand-drawn notation connected to another machining step irrespective of by whom the hand-drawn notation is drawn. The software application can preferably be using artificial intelligence (AI) to associate a hand-drawn notation drawn by a person, whose hand-drawn notations are not already in the library, with the correct machining step, using all the hand-drawn notations and the corresponding machining steps of the library.

The presentation on the display device how the machine step will be done is like a feedback system and will give the user a good opportunity to check whether the hand-drawn notation was correct in the first place, and/or the software application has understood the hand-drawn notation correctly.

How the first workpiece is machined—the machining process—can be a simple process, where the first workpiece is machined leaving a machined surface of the workpiece, where the machined surface does not change in the thickness direction. The simple machining process can be a straight cut or the simple machining process can follow a curved line, but since there is no variation in the profile of the straight cut or the curved line in the third direction or the thickness direction, all information about the machining process can be presented on one single surface of the workpiece, the surface facing the image recording device.

The machining process can be a complicated process, where the machined surface left on the first workpiece after the machining process varies with the thickness of the first workpiece or in other words in the thickness direction. In that case, hand-drawn notations on more than one surface of the first workpiece may be necessary as well as two or more images captured by the image recording device from different positions and/or with the workpiece rotated and/or moved between the two or more captured images.

Suppose we have a workpiece stretching in the z-axis that is supposed to be cut perpendicular to the z-axis. A straight line perpendicular to the z-axis across only a first surface of the workpiece will tell that the machining is a simple process. A continuation of the straight line on another second surface of the workpiece, where the continued line is still perpendicular to the z-axis, will not give any further information about the machining process, but will only confirm the information already found on the first surface.

If the straight line on the first surface forms an angle that is not 90° with the z-axis, or if the straight line is replaced by a curved line on the first surface, while the intended machining process of the workpiece is otherwise not different from the above-mentioned intended machining process with the straight line perpendicular to the z-axis, hand-drawn notations on the first surface can comprise all information to be able execute the machining process. These machining processes are simple processes.

If the line on second surface is not perpendicular to the z-axis, but forms an angle that is not 90° with the z-axis the machining process will be a complicated process, since the hand-drawn notation on the first surface is not enough information to perform the machining process. However, in this situation the second surface has enough information for the machining process to be correctly performed, and with the second surface considered the first surface this machining process will be a simple process.

To speed up the machining process, a first hand-drawn notation applied on the first surface can indicate that the hand-drawn notations on the first surface is enough to correctly perform the machining process (simple process) and the software application and/or the machine tool system will understand that the information in the first captured image is enough to perform the machining process.

Any machining process of the workpiece is possible, as long as all information about the machining process can be included in hand-drawn notations on the workpiece.

If the user considers that the machine tool system has not understood the handwritten sign(s) correctly, the user can make corrections by making additions to the handwritten sign(s) on the first workpiece and repeat the capture of the image, the associating step and the presenting step. Alternatively, the user can make alterations or additions to the image presented on the display device.

When presenting on a display device the at least one machining step of the machine tool system on or in relation to the captured image, the at least one machining step of the machine tool system can be superimposed on the first workpiece on or in relation to the captured image on the display device. The part of the first workpiece about to be removed can e.g. be given a clear colour to have the removed part stand out.

When the user considers the machining process as presented on the display device to agree with the machining process the user intends for the first workpiece, the user will approve the machining process as presented on the display device by e.g. pressing an approval button. Preferably, the software application executable on a machine tool system for machining a workpiece will control a tool of the machine tool system for machining the first workpiece according to the one or more notations maybe with additional corrections added by the user on the display device.

When controlling the tool of the machine tool system for machining the first workpiece according to the one or more notations, and possibly any addition made on the display device, the machine tool system will take care of thickness and diameter of e.g. a circular cutting blade or the diameter and length of e.g. a rotary cutter so that the machined surface left on the first workpiece after the machining process is, where the machined surface should be.

Thus, it is possible to minimise the time it takes to cut a workpiece, and the end result will be an even more precise cut.

Such a software application executable on a machine tool system for machining a workpiece will transform the machine tool system so that the machine tool system is very easy to control, and any person without any or by a very short introduction will be able to control the machine tool system.

In an embodiment, the software application can be configured for executing the steps of presenting on the display device

a distance from a first point on the first workpiece to a second point on the first workpiece, where the machining step will be machining the first workpiece according to the one or more notations, and/or

an angle between a first direction of the first workpiece and a second direction of the first workpiece, in which the machining step will be machining the first workpiece according to the one or more notations.

Even though no information about the distance and/or angle has been given to the software application and/or the machine tool system in which the software application is executed, the software application and/or the machine tool system in which the software application is executed can be

By presenting the distance and/or the angle on the display device, the user will easily be able to determine whether the software application and/or the machine tool system in which the software application is executed has understood the instruction correctly.

By drawing e.g. an arrow on a first workpiece starting at one end of the first workpiece and ending with the point somewhere on the first workpiece and drawing a number next to the arrow, the software application and/or the machine tool system in which the software application is executed can be adapted to understand the arrow and number as an instruction to cut/machine the first workpiece so many length units from the first point and/or the one end of the first workpiece. The user will not need to mark the line correctly on the first workpiece, but the software application and/or the machine tool system in which the software application is executed can be adapted to understand what the user is intending and present the machining process on the display device for approval. That the user will not need to mark the line correctly on the first workpiece will save time. The length unit will be the most appropriate length unit and can be changed. In most of Europe, and most of the rest of the world, the most appropriate length unit will be mm or maybe cm, while in the US and in the UK the most appropriate length unit may be inches.

If a sign indicates that e.g. a circle or a circle arc is to be cut out, the distance from the first point to the second point can be a radius or a diameter of the circle or the circle arc.

In an embodiment, the display device can be an electronic screen, augmented reality glasses, virtual reality glasses, a hologram illuminated by light, and/or a brain-computer interface.

The display device and/or the electronic screen can be a cathode ray tube, a liquid crystal display (LCD), a light-emitting diode (LED) display, a plasma display.

In an embodiment, the software application is configured for executing the steps of:
i. presenting on the display device the option of either including or excluding the one or more hand-drawn notations in the part of the first workpiece that is removed when machining the first workpiece.

If a first workpiece is to be machined to have a certain length, if no number for indicating the length in the length unit used is drawn on the first workpiece, and if a hand-drawn notation in the form of (straight or curved) line is drawn at that certain length from the end of the first workpiece, the machining step should preferably machine the first workpiece so that half of the hand-drawn line is left on the first workpiece after the machining step so that the first workpiece after machining step has the desired length.

If a first workpiece is to be machined to have exactly the same length and end profile as a second workpiece, the second workpiece can be placed exactly on top of the first workpiece, and a hand-drawn line can be drawn on the first workpiece following the end profile of the second workpiece, then the machining step should preferably machine the first workpiece so that nothing of the hand-drawn line is left on the first workpiece after the machining step so that the first workpiece after machining step has the desired length.

The software application will have to consider the width, thickness and/or diameter of the tool when machining the first workpiece for the machined first workpiece to have the right dimension/length.

So sometimes the machining step should leave the hand-drawn notation or at least a part of the hand-drawn notation and sometimes the machining step should just remove all but not more of the first workpiece having the hand-drawn notation. Since the software application in most cases cannot know whether the hand-drawn notation should be left or removed because it will depend on the situation, it will be preferable to have the option of indicating to the software application preferably on the display device whether the hand-drawn notation should be left or removed. If the software application controls a rangefinder, like a laser rangefinder, the software application can tell e.g. on the display device the length of the first workpiece after the machining step with the hand-drawn notation left and/or with the hand-drawn notation removed. If the user knows what the length of the first workpiece after the machining step should be, to show the length on the display device can be an extra help.

In an embodiment, the image recording device can be a camera, preferably a digital camera like a CCD camera or a camera with an active-pixel-sensor like e.g. a CMOS sensor.

In an embodiment, the software application can be configured for executing the steps of:

a. presenting on the display device different types of connections between the first workpiece and a second workpiece,
b. receiving instruction about the type of connection to connect the first workpiece and the second workpiece, and
c. optionally controlling the tool of the machine tool system for machining the first workpiece according to the one or more notations and according to the type of connection to connect the first workpiece and the second workpiece, and
d. optionally controlling the tool of the machine tool system for machining the second workpiece according to the one or more notations and according to the type of connection to connect the first workpiece and the second workpiece.

The second workpiece can also have one or more notations and controlling the tool of the machine tool system for machining the second workpiece according to the one or more notations can be according to the one or more notations of the first workpiece and/or the one or more notations of the second workpiece.

The sign can be a circular arc combined with a number indicating the angle between the first workpiece and the second workpiece when the first workpiece and the second workpiece are assembled.

To machine two workpieces in one step saves time and decreases the risk of a faulty machining.

The type of connection to connect the first workpiece and the second workpiece can be of a type where the first workpiece has a male-shaped end and the second workpiece has a corresponding receiving female-shaped end or vice versa. Such a connection will be extra strong. In addition, such a connection between the first workpiece and the second workpiece can be glued together to a very strong connection due to the additional surface area in the cross-section. That will be extra beneficial for connecting workpieces of wood, metal or plastic.

The connection between the first workpiece and the second workpiece can be any other mating connection, where both the first workpiece and the second workpiece have a male-shaped end and a female-shaped end, where the male-shaped end of the first workpiece corresponds to the female-shaped end of the second workpiece, and vice versa, so that a very strong connection between the first workpiece and the second workpiece.

In an embodiment, the software application can be configured for executing the step of determining for each of the one or more hand-drawn notations whether the one or more hand-drawn notations is/are

a. a straight or curved line, and/or
b. a number and/or one or more letters, and/or
c. a symbol.

The straight or curved line can indicate exactly where and/or at the exact angle to cut the workpiece. That will preferably be the case when there is just a line and no other sign with further information. The tool of the machine tool system can be controlled by the software application to machine the workpiece along the straight or curved line, where the line is left or is not left on the workpiece.

The number can be used for indicating how long a length should be, how wide an angle should be, how large a radius/diameter of a circle should be, and/or how large a radius of a circular arc should be. The advantage is that the line indicating the cut does not have to be exact at the correct position with the correct angle. By adding a number indicating the length, diameter, radius or angle how to apply the cut, the user does not need to use time to exactly apply the line, where the cut should be. The line preferably just needs to be in the vicinity and indicate how the cut should be, like e.g. across the workpiece, a rectangle cut-out, or a circular cut-out etc.

The one or more letters can e.g. be a unit, like millimetre (e.g. written mm), centimetre (e.g. written cm), or inch (e.g. written in) added to a hand-drawn number. The unit inch can also be written by the symbol ″.

The symbol can be to indicate which part to keep and which to dispose. It can be preferable to cut the part to dispose in two to save machining time, but the part or workpiece to keep should not be cut in two.

The symbol can e.g. be used for indicating whether the cut should be applied so that the line is removed by or kept after the cut.

For the software application to correctly interpret the instructions from the user it is preferable that the software application correctly determines the type of hand-drawn notations that can be found on the workpiece. It is important that a straight line is interpreted as a straight line and not as a number “1”. Likewise, a number “1” should preferably not be interpreted as a straight line.

The software application can preferably be configured for using artificial intelligence or an artificial intelligent module, wherein the artificial intelligence or the artificial intelligent module has an electronic library with numbers and symbols. The software application preferably by the help of artificial intelligence or the artificial intelligent module can compare the one or more hand-drawn notation with the electronic library to determine whether each one of the notations is a straight or curved line, a number, or a symbol, and if a notation is considered a number or a symbol, which number or which symbol the notation is.

The software application can use the approval or disapproval by the user regarding the at least one machining step of the machine tool system on or in relation to the captured image, and/or the first workpiece as the first workpiece will appear after machining the first workpiece according to the at least one machining step of the machine tool system, to improve the electronic library and increase the rate of correct interpretations of future associations of whether the hand-drawn notations are a straight or curved line, and/or a number, and/or a symbol.

Paths are considered any instance of open or closed curves, drawn by the user on the workpiece. An open curve denotes a curve, in which the starting point and end point of the curve are not coinciding. This may take the form of straight lines or curved lines.

Closed curves denote a curve, in which the start and end points are coinciding. These may be distinguished in closed curves, which can be conformed to geometric primitives, such as circles, ellipsoids, triangles, rectangles and other polygons; or arbitrary closed curves that does not conform to known geometric primitives.

In the context of the present disclosure, the paths is considered the interpretation of user hand-drawn curves to designate a desired toolpath for a machining process, e.g. a straight line to be followed by a digitally controlled saw to perform a cut; or a curve to be followed by a digitally controlled point-tool to machine any arbitrary shape.

Image content in the form of text, denote any numeral system used to indicate numeric information hand drawn on the workpiece by the user, or it may denote any element(s) of an alphabetic system used to supply additional information, such as part numbering or units of measurement. In the context of the present disclosure, the utility of texts is for the user to—by hand-writing/hand-drawing on the work-piece—provide supplementary information to a hand-drawn notation. This could be in the form of e.g. stating in numeric form a desired dimension of a line; a desired angle of a line; or a desired diameter of a circle, etc.

Image content in the form of symbols denote any recognizable combination of curve segments that through digital processes can be abstracted to generic symbols; or system specific symbols stored in a library. In terms of generic symbols, this could be in the form of dimensional arrows or dimension lines; cross-markings; or angled lines denoting perpendicularity. In the context of the present disclosure, the utility of symbols is to enable the user through hand-drawing to instruct a machining system with specific, pre-determined commands that are associated to other hand-drawn content.

In an embodiment, the symbol can be a first symbol, e.g. an arrow, for indicating a length, or a second symbol, e.g. a circular arc, for indicating an angle, or a third symbol for indicating whether a line should be left on the workpiece to be kept.

Length and angle will be the most common parameters used when machining the workpiece. If there is no hand-drawn notation indicating a length, the third symbol will be preferable to achieve a cut at the correct place.

In an embodiment, the software application can further be configured for executing the steps of associating a first hand-drawn notation determined to be a number with a second hand-drawn notation determined to be a straight or curved line, or to be a symbol.

A number will be written on a workpiece to indicate e.g. a length the workpiece should have after the machining process or an angle a cut should have to a side of the workpiece. It is important that the number is associated with the correct straight or curved line, or the correct symbol.

If the first hand-drawn notation is written within a distance from second hand-drawn notation in the form of e.g. an arrow, where the distance is less than a predetermined threshold distance, the first hand-drawn notation and the second hand-drawn notation could be associated to each other.

The direction of the first hand-drawn notation can also be an indication what the number is intended to tell. If the length of the workpiece is to be shortened, the number telling the length after the machining will in most cases be written in the longitudinal direction of the workpiece. A number written in the longitudinal direction next to a second hand-drawn notation in the form of an arrow pointing in the longitudinal direction will probably mean that the number and the arrow together indicate that the workpiece should be machined with a length indicated by the number. The length of the arrow may also tell whether the number should be interpreted as a length in mm, cm, or inch, etc.

If the workpiece is supposed to be made narrower the number will be written in a direction across the workpiece. If there is also a second hand-drawn notation in the form of an arrow pointing across and not in the longitudinal direction of the workpiece, the number should probably be associated with the arrow across the workpiece.

A first hand-drawn notation next to a second hand-drawn notation in the form of an arc between e.g. a side of the workpiece and yet another second hand-drawn notation in the form of a line stretching from that side will probably indicate that the workpiece should be machine at an angle indicated by the number.

These are possible associations, which artificial intelligence or an artificial intelligent module preferably with a large and good electronic library will be able to make correctly and in no time.

The one or more letters, mentioned above, can be a sequence of letters forming a word with instruction to the software application. Next to a line the word “straight” can be written, so that the software application associates the line and the word “straight”, for indicating that the line should be understood to be straight. Likewise, the word “perpendicular” next to a line would indicate that the line should be perpendicular to a side of the workpiece. The word “arc” next to a curved line would indicate that the line should be understood to be an arc of a circle with a common centre. An additional number close to the curved line and/or the word “arc” could then be interpreted as the radius of the arc. These are just a few examples. Others are also contemplated according to present invention.

In this way, the software application has the ability to find out how the user intended to machine the workpiece.

In an embodiment, the second hand-drawn notation can be a straight or curved line, and wherein if the position of the machining step according to the second hand-drawn notation does not coincide with the machining step according to the number, the software application can be configured for executing the step of interpreting the machining step indicated by the second hand-drawn notation to be in accordance with the number.

If e.g. the location of the straight or curved line is not coinciding with where the machining step like e.g. a cut is supposed to be according to the number hand-drawn on the workpiece the software application can be configured to understand that the machining step is intended by the user to be where the number tells the machining step to be.

The advantage is that the user can measure correctly how long or wide a workpiece should be after the machining step, but the user does not need to measure again and draw correctly on the workpiece, where the machining step should be. The user only needs to draw approximately where the machining step should be, the software application when executed will understand, where the machining step should be based on the number. A lot of time will be saved. In addition, the risk of the machining step being at the wrong position because of a line drawn at the wrong place is eliminated.

A line indicating a machining step like a cut will still be valuable, since the line will show that the user e.g. indicates to cut the workpiece and enable the software application to be able to understand what is intended by the number.

Likewise, a number positioned close to a line, where the angle, which the line and a side of the workpiece create, is not so far from the number will tell the software application when executed that the machining should be with the angle indicated by the number.

To associate the number and the line drawn at an angle, the user could preferably add a sign in the form of an arc between the line and the side of the workpiece.

By adding another number, in addition to the number indicating the angle of the machining step, somewhere between, where the line start at the side of the workpiece and the end of that side of the workpiece, the software application when executed will understand, where to start the machining step and in which direction the machining step should go.

In an embodiment, the software application can be configured for interpreting a hand-drawn notation within the content of a recorded image in order to extract from the hand-drawn notation a number, and for manipulating a location of a line in the captured image based on the number.

The invention also relates to a machine tool system as mentioned above for machining a workpiece, wherein the machine tool system is configured to be controlled by the software application.

The machine tool system configured to be controlled by the software application will have all the benefits mentioned above.

Such a machine tool system will be very easy to control, and any person without any or by a very short introduction will be able to control the machine tool system.

In an embodiment, the machine tool system can comprise an image recording device preferably positioned on a joint arm.

The machine tool system comprising the image recording device will be able to take a photo of the hand-drawn notation(s) on the workpiece and interpret the hand-drawn notation(s) so that the machine tool system knows exactly how to cut the workpiece.

Preferably, image recording device is positioned on the joint arm so that the image recording device can always be moved close to the workpiece and the hand-drawn notation(s), so that a captured image by the image recording device will be a true reproduction of the hand-drawn notation(s) without disturbing light reflections and without unwanted items between the image recording device and the workpiece.

In an embodiment, the machine tool system can be integrated in the portable manufacturing unit as described above and below.

The manipulator of the portable manufacturing unit can be configured for machining the workpiece according to the any of the steps of the software application mentioned above or below. The workpiece can be positioned on the bed for the manipulator to move the workpiece to the external axis, or the workpiece can be positioned directly on the external axis. The machine tool system according to this embodiment will be very adaptable and able to machine a material stack as well as the single piece with the hand-drawn notation.

The invention also relates to a method of machining a workpiece using a tool of a machine tool system comprising the steps of

a. handdrawing one or more hand-drawn notations on a first workpiece,
b. capturing an image of the first workpiece having the one or more hand-drawn notations using an image recording device,
c. associating the one or more hand-drawn notations with at least one machining step of the machine tool system,
d. controlling a tool of the machine tool system for machining the first workpiece according to the one or more notations.

The machine tool system configured to be controlled by the software application will have all the benefits mentioned above.

In an embodiment, the method further can comprise any of the steps of method described herein.

### BRIEF DESCRIPTION OF THE DRAWINGS

The invention will in the following be described in greater detail with reference to the accompanying drawings:

FIG. 1 a schematic view of a flow-chart diagram for machining a workpiece;

FIG. 2 a schematic view of a computer-controlled fabrication system;

FIG. 3 a schematic view of the computer-controlled fabrication system in more detail;

FIG. 4 a schematic view of a flow-chart diagram of the algorithmic process of line/curve detection;

FIG. 5a a schematic view of diagrammatic description of the algorithmic process to detect a straight line;

FIG. 5b a schematic view of diagrammatic description of the algorithmic process to detect a curved line;

FIG. 6a a schematic view of a computer-controlled fabrication system positioned in a trailer;

FIG. 6b a schematic view of another embodiment of a computer-controlled fabrication system framed within a trailer;

FIG. 6c a schematic view of another embodiment of a computer-controlled fabrication system positioned in a trailer;

FIG. 7 a schematic view of a rotatable worktable and a robotic manipulator with a tool;

FIG. 8 a schematic view of a flowchart diagram showing the step of interpretation of hand-drawn notations;

FIG. 9 a schematic view of different notations;

FIG. 9a a schematic view of a board with notations;

FIG. 9b a schematic view of a board with other notations; and

FIG. 10 a schematic view of a flow-chart diagram of symbol processing.

### DETAILED DESCRIPTION OF THE INVENTION

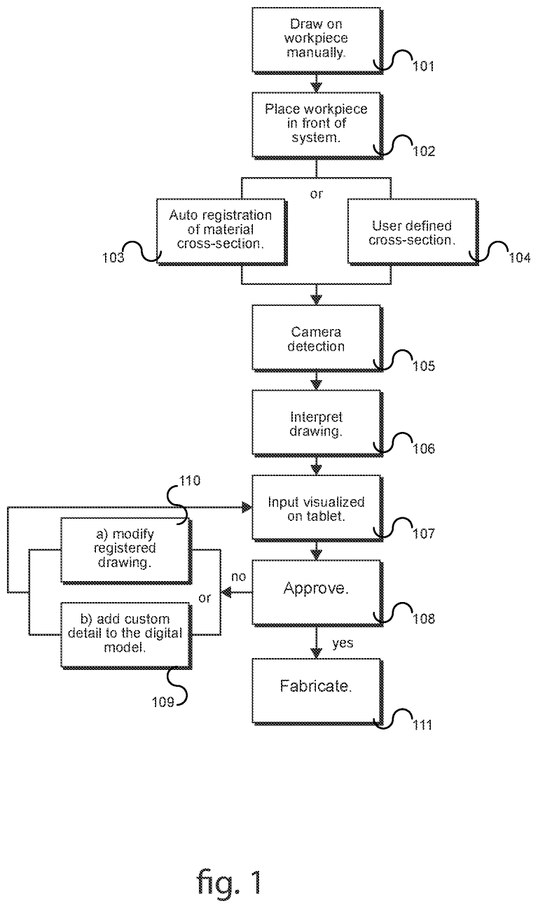

FIG. 1 shows a diagram that describes the workflow for machining a workpiece from start to finish.

The workflow starts by the user drawing one or more hand-drawn notation on the workpiece in a step 101. In a step 102, the workpiece is placed in front of the computer-controlled fabrication system.

If a thickness of the workpiece has been given as an input to the computer-controlled fabrication system already by the user, the computer-controlled fabrication system will adapt the machining process based on the given thickness as in a step 104.

In a step 103, if a thickness of the workpiece has not been given by the user, the computer-controlled fabrication system will instruct a camera or an image recording device to capture an image of a side of the workpiece. The side of the workpiece may be visible from the position of the camera, or the workpiece is rotated to expose the side of the workpiece to the camera, or the camera is moved to better capture an image of the side of the workpiece. Alternatively, a combination of two or all three of the alternatives is also possible. The thickness of the workpiece can be determined by an earlier calibration with the camera in the same position, where the ratios between distance in the image and length on the side of the workpiece are determined.

By determining the thickness of the workpiece, the computer-controlled fabrication system will know whether a tool attached to and controlled by the computer-controlled fabrication system is able to machine the side of the workpiece in one stroke or a lower part of the workpiece has to be machined in a second stroke or round by the tool.

Alternatively, if the thickness of the workpiece is too large for the tool, the computer-controlled fabrication system might indicate for the user that the tool has to be exchanged for another larger tool that is able to machine the side of the workpiece in one stroke.

In a step 105, the camera or the image recording device is used to capture an image of the one or more hand-drawn notation drawn on the workpiece. The digital information from the camera is algorithmically interpreted in a step 106, which i.a. can mean that pixels in the image, which depict dye or pigment from e.g. ink or graphite are set apart from pixels in the image, which do not depict dye or pigment. The pixels determined to depict dye or pigment together form notations.

The notations can be compared to stored notations. An arrow up to a line across a first workpiece in the form of a board to be machined combined with a handwritten number on the first workpiece can mean that the first workpiece should be machined or cut the handwritten number of e.g. mm away from a short end of the first workpiece wherefrom the arrow originates. The software can be set to interpret the handwritten number in another length unit than mm like e.g. cm or inch. A circular arc between a side of the first workpiece and a hand-drawn line across the first workpiece combined with a handwritten number on the first workpiece can mean that the first workpiece should be machined or cut in an angle corresponding to the handwritten number in e.g. degrees radians depending on how the interpreting software is set.

A hand-drawn notation in the form of a straight or curved line on the first workpiece can tell that the first workpiece should be machined along the straight or curved line.

In a step 107, how the software has interpreted the one or more hand-drawn notations as they appear in the captured image is visualised on a display device such as a tablet.

The user can approve or disapprove the interpretation in a step 108. The disapproval can be an indication that the user wants to add one or more custom details to the digital model or to modify the registered drawing.

The user can add one or more custom details to the digital model in a step 109, where the added custom detail can be joinery information between a first workpiece and a second workpiece. The joinery information can e.g. be the angle under which the two workpieces are supposed after the machining processes of the two workpieces. The joinery information can e.g. be that both workpieces, supposed to meet each other at a certain angle, should be machined or cut with half that angle. The joinery information can e.g. be that the two workpieces should meet each other with an overlap so that an upper part of the first workpiece is removed while the lower part of the first workpiece is not removed, and so that an lower part of the first workpiece is removed while the upper part of the first workpiece is not removed, and wherein the upper parts are correspondingly machined to meet each other when the two workpieces are assembled, and wherein the lower parts are correspondingly machined to meet each other when the two workpieces are assembled. Such a joint gives an extra strong connection between the two workpieces. The joinery information can e.g. be that the two workpieces should meet each other with an overlap in three layers, where an end of the first workpiece has a U shape and an end of the second workpiece has a corresponding T-shape that fits in the U-shape end of the first workpiece.

The added custom detail can be whether the machining shall leave or not leave the hand-drawn notation in the form of a line on the first workpiece after the machining.

Instead of or in addition to the step 109, the user can modify the registered drawing in a step 110.

The modification can e.g. be a modification of the interpretation of a handwritten number, e.g. by typing the right number as an input to the computer-controlled fabrication system replacing the wrong interpretation of the handwritten number.

If a straight line has wrongly been interpreted as a curved line, the modification can be a modification of the curved line to a straight line.

The modification can also be a supplementary hand-drawn notation on the first workpiece so that process starts again in the step 101. In many situations it is easier to add a hand-drawn notation on the first workpiece than to modify the visualized input on the display device.

After the addition(s) in the step 109 and/or the modification in the step 110 the diagram leads back to the step 107 for another approval in the step 108.

When the user approves of the visualized input or interpretation of the computer-controlled fabrication system, the first workpiece is machined or fabricated in a step 111 by a tool controlled by the computer-controlled fabrication system.

When the joinery information is chosen in the step 109, and the first workpiece has been fabricated in the step 111, the second workpiece can be placed in front of the system as in the step 102 without any hand-drawn notation on the second workpiece; the software can store the information chosen for the first workpiece and use that information when machining the second workpiece. Alternatively, notations are hand-drawn on the second workpiece to instruct the computer-controlled fabrication system as was done for the first workpiece.

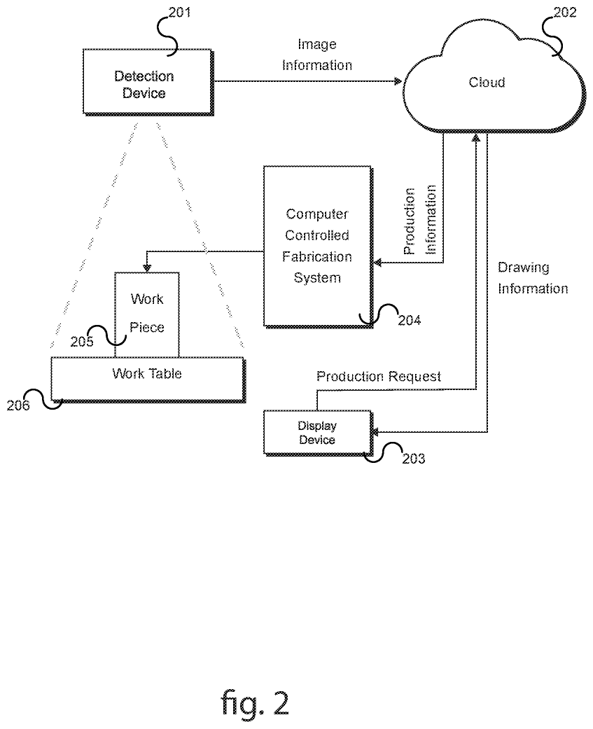

In FIG. 2, the computer-controlled fabrication system is shown comprising detection device like a digital camera 201 like a CCD camera for capturing images of a workpiece 205, which contains the hand-drawn drawing, where the workpiece 205 is placed on a worktable 206. The camera 201 can be mounted externally or on a computer-controlled fabrication device 204.

The computer-controlled fabrication device 204 can be a robotic arm, with a tool mounted. The robotic arm can have one, two, three or more linkages and be positioned on a base that can be rotated 360° and/or can be slidable along a direction parallel or perpendicular to the workpiece 205 to give that necessary mobility of the computer-controlled fabrication device 204 that the task requires.

The computer-controlled fabrication device 204 can be a computer numerical control (CNC) of machining tools (drills, boring tools, lathes) and 3D printers by means of a computer.

The worktable 206 can be moved horizontally in one or two dimensions for moving the workpiece 205 so that all parts of the workpiece 205 can be machined by the computer-controlled fabrication device 204.

The computer-controlled fabrication system also comprises a server 202, which can be in the cloud, and display device like a tablet user interface (UI) 203, where the tablet UI can be any form of electronic interface having a display device for showing an image and having an electronic connection for wired or wireless two-way communication with the server 202.

The camera 201 is in a wired or wireless communication with the server 202.

The server 202 is also in a wired or wireless communication with the computer-controlled fabrication device 204 for controlling the computer-controlled fabrication device 204.

When machining the workpiece 205, the user draw the hand-drawn notation on the workpiece 205 for instructing the computer-controlled fabrication system how to machine the workpiece 205. The workpiece 205 is placed on top of the worktable 206.

The user then instructs the computer-controlled fabrication system through the tablet 203 to start the machining process of the workpiece 205 by capturing an image of the workpiece 205 by the camera 201. The image data of the image is sent from the camera 201 to the server 202. The server 202 processes the image data including the hand-drawn notation to find out how to machine the workpiece 205. The processing can preferably be a translation of the image data into CAD information that can be used to control the computer-controlled fabrication device 204.

The processed or translated image data is sent to the tablet 203, where the workpiece 205 is shown in the image together with the machining step to be performed as understood according to the processing of the server 202. If the computer-controlled fabrication device 204 controls a tool e.g. in the form of a circular cutting blade, the tool will preferably be machining the workpiece 205 by making straight cuts. If the computer-controlled fabrication device 204 controls a tool e.g. in the form of a rotary cutter, the tool can be machining the workpiece 205 along straight lines and/or curved lines.

If the machining step is machining along a straight line, the angle of the straight line in relation to another suitable direction as e.g. an edge of the workpiece 205 is preferably shown in the processed image.

If the machining step is machining along a curved line, the angle of a tangent of the curved line at an edge of the workpiece 205 in relation to a suitable direction as e.g. the same or another edge of the workpiece 205 is preferably shown in the processed image.

The processed image as shown on the tablet 203 will show whether the hand-drawn line along which the machining should be performed is left on the workpiece 205 after the machining process. If the processed image shows that the line is left on the workpiece 205 after the machining process even though the line should be removed, or vice versa, the user can give that input on the tablet 203 to the server 202 so that the processed image as shown on the tablet 203 is updated with this new information.

The hand-drawn notation can e.g. also be a handwritten number, a circular arc and/or an arrow as discussed above in relation to the diagram in FIG. 1.

The tablet 203 communicates with the computer-controlled fabrication device 204 via the server 202. Once an approval or a machining signal is received, the computer-controlled fabrication device 204 will start machining the workpiece 205.

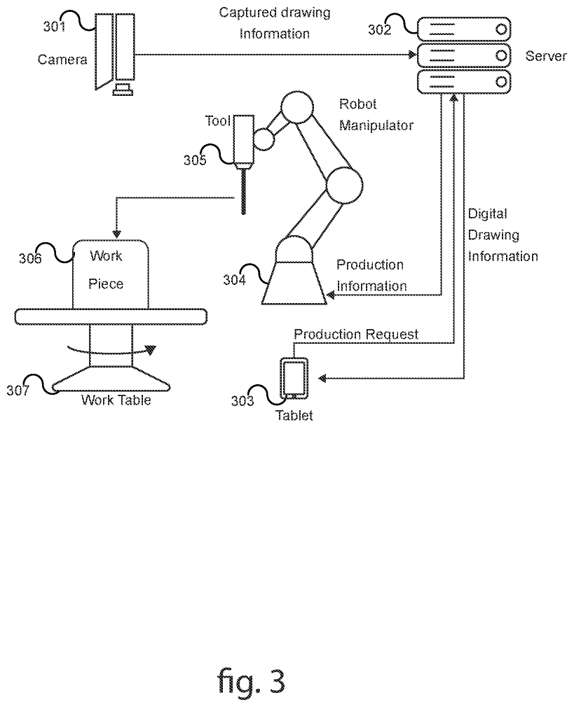

FIG. 3 shows the computer-controlled fabrication system of FIG. 2, where the computer-controlled fabrication device is a robot manipulator 304 with a tool 305 mounted on the robot manipulator for machining a workpiece 306 positioned on a worktable 307. The worktable has an external rotating axis and/or an ability to displace the workpiece linearly so that the workpiece can be positioned in a good position during the machining.

A camera 301 captures an image of the workpiece 306. The camera 301 can be positioned at a fixed place, on a joint arm so that the position of camera can be changed (e.g. to be able to capture images of the side of the workpiece or of all the workpiece even if the workpiece is long), or on the joint arm of the robot manipulator 304.

A local server 302 receives information from the camera 301 and translates the information into CAD information that is sent to a tablet UI 303. The tablet 303 is used to interpret, alter and add information to the captured information and present the information to the user on a user interface (UI) like a screen. Once satisfied, the user will send a fabrication signal to the server via the tablet 303, which in turn sends fabrication information to the robot manipulator 304.

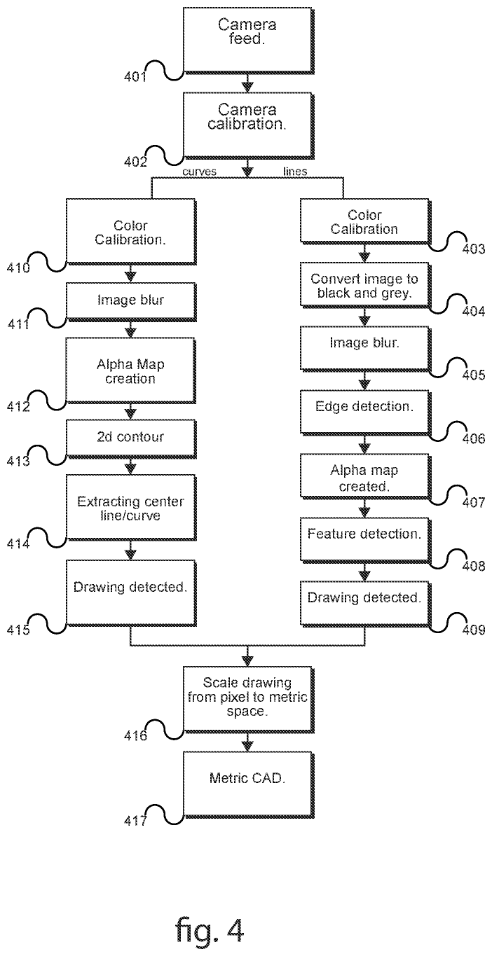

In FIG. 4, a diagram is shown describing the algorithmic process of line/curve detection. This is one example. Other examples are possible.

In a step 401, the camera generates image data by capturing an image of the workpiece.

In a step 402, a camera calibration is applied to the image data, ensuring that there is no spherical distortion in the image/video from which the drawing is detected.

It is determined whether the hand-drawn notation is a straight line or a curved line. Manual selection is also possible.

The curved line can be a curved line, or the curved line can be a number or a sign having a curved segment. If a line, number or sign has both a straight line and a curved line connected to each other, the line, number or sign may be dealt with as a curved line, or maybe considered as separate lines—one or more straight lines and one or more curved lines.

Dependent on the outcome of whether a line is straight or curved a selection mechanism in step 402 sends the analysis further along some steps 403-409 for analysing straight lines or along some steps 410-415 for analysing curved lines. The steps 403-409 and the steps 410-415 resemble each other.

The workpiece will not be a perfect, white piece, and the hand-drawn notation will not be totally black, but will have structures that can resemble e.g. the ink or graphite from a pen or pencil. A workpiece of concrete will be greyish with some small cracks having a darker colour. A wooden workpiece will have structures in the surface of the wooden workpiece due to e.g. growth rings. The cracks and growth rings must not be interpreted as hand-drawn notations or as parts of a handwritten sign. For that reason, the image of the workpiece with the handwritten sign has to be processed so that the handwritten sign is emphasised and lines in the image due to structures in the workpiece itself are eliminated.

In a step 403 for line detection, the colour of the image/video is calibrated, by making colours more vibrant or by removing certain colour values and substituting them with white/black. The advantage of the calibrated colours is that the handwritten sign(s) is/are accentuated and background noise is removed so that it is easier for the system to correctly read and interpret the handwritten sign(s).

In a step 404, the image is converted to black and grey and white to simplify the computational process.

In a step 405, the image is blurred to remove noise.

In a step 406, edge detection is performed on the blurred image. The edge is determined to be between adjacent pixels having a difference in darkness above a certain threshold.

In a step 407, the edge detection is used to make an alpha map (containing only white/black colours). Inside the edges the pixels will be only black and outside the edges the pixels will be only white, or vice versa. The edges are removed so that the alpha map does not have the edges.

In a step 408, a feature detection is performed based on the alpha map, where a line is applied somewhere in the middle of the black or white pixels, which earlier were inside the edges.

In a step 409, the hand-drawn notation is detected and distinguished from the rest of the image.

In a step 410 for curve detection, the colour is calibrated as in the step 403 and for the same reason.

In a step 411, the image is blurred as in the step 405 and for the same reason.

In a step 412, the image is converted to an alpha map (similarly to the output of step 407) using a threshold technique for the same reason.

In a step 413, 2D contour is performed on the image.

In a step 414, centre lines are extracted from the 2D contour.

In a step 415, the curve is detected based on the extracted line.

In a step 416, Curve/line is scaled from pixel space to metric space so that the robot manipulator and the tool of the robot manipulator can be controlled to perform the right machining at the right scale or dimension. It is important that the scaling is correct so that the cut or machining will be at the correct location.

In a step 417, a metric CAD representation of the drawing is visualized on the tablet so that the user can approve, modify or disapprove the way the computer-controlled fabrication system has understood the hand-drawn notation.

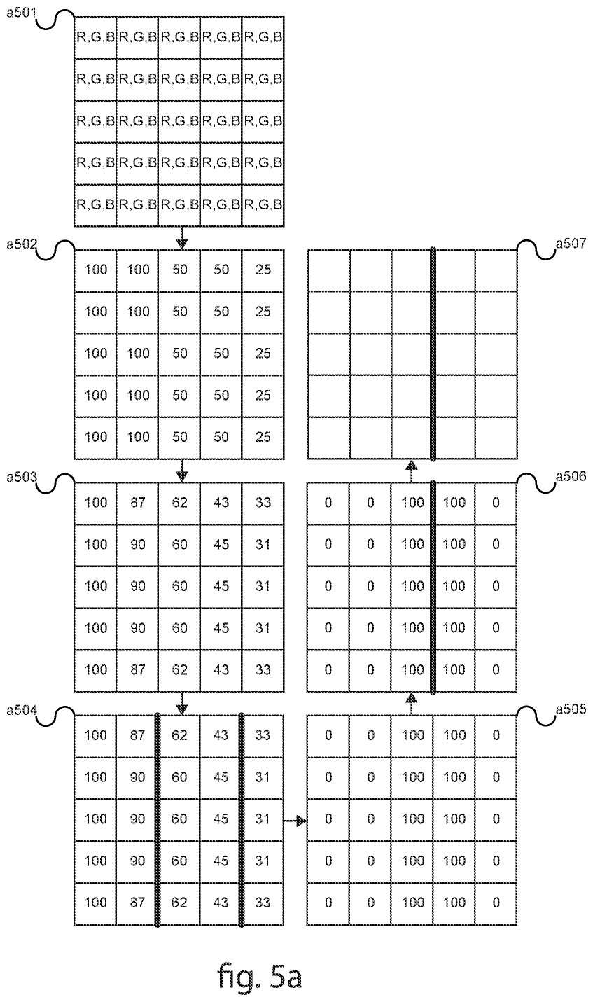

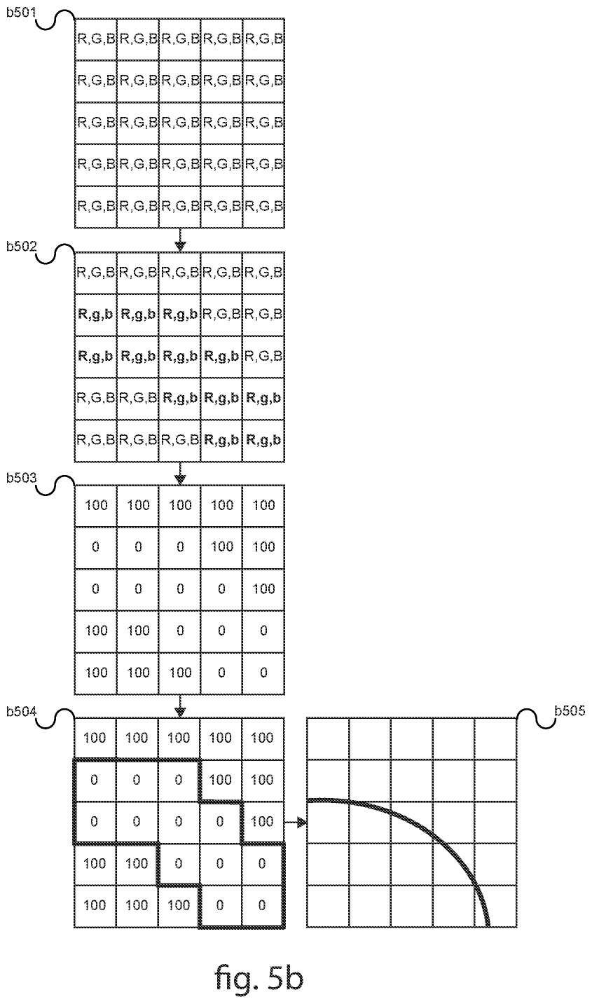

FIG. 5a shows a diagrammatic description of the algorithmic process to detect a line as described in the steps 403-409, where a captured, coloured image has been processed so that the colour of the captured image is calibrated, and we have a colour calibrated image a501.

The colour calibrated image a501 is converted to a black and grey (100=white and 0=black) image a502.

The black and grey image a502 is blurred by performing a gaussian blur, which averages neighbouring pixels, and we have a blurred image a503.

Edge detection is performed on the blurred image a503 so that sudden changes in intensity (changes in intensity between neighbouring pixels) can be identified, and we have an image with edge detection a504.

The image with edge detection a504 is converted by alpha mapping to an alpha map image a505.

In the alpha map a505 feature detection is performed, which returns a generalized description of a line or a generalized line in the form of a point and angle as shown in a feature detection image a506.

The generalized line in the feature detection image a506 is converted to a conventional line information image a507 with a start point and an end point, or with start coordinates for the start point and end coordinates for the end point. In this way, the hand-drawn notation in the form of a straight line can be translated into a line with a well-defined start point and a well-defined end point, where the conventional line information image a507 with the well-defined line can be sent to the tablet for approval by the user, where the well-defined line will represent a machining process like e.g. a straight cut or milling process along the well-defined line.

FIG. 5b shows a diagrammatic description of the algorithmic process to detect a line as described in the steps 410-415. First, an imported image b501 is captured by the camera and sent to the server to be processed.

The imported image b501 where a captured, coloured image has been processed so that the colour of the captured image is calibrated enhancing a colour spectrum, and we have a colour calibrated image captured b502. The colour calibrated captured image b502 may have been optimized through an application of blur algorithm used above when processing the black and grey image a502 to achieve the blurred image a503.

The colour calibrated captured image b502 is converted by alpha mapping to an alpha map captured image b503.

The alpha map captured image b503 is further processed for extracting a 2D contour by adjusting the colour value for pixels within a predefined threshold limit to 0 and for pixels outside the threshold to 100 and receiving a 2D contour image b504.

Finally, a centreline for the contour is found in and added to the 2D contour image b504 to receive a centreline image b505. There are many mathematical models that can be utilised to achieve a good and correct position of the centreline. In this way, the hand-drawn notation in the form of a curved line can be translated into a line with a well-defined start point and a well-defined end point, where the centreline image b505 with the centreline can be sent to the tablet for approval by the user, where the centreline will represent a machining process like e.g. a curved milling process along the centreline.

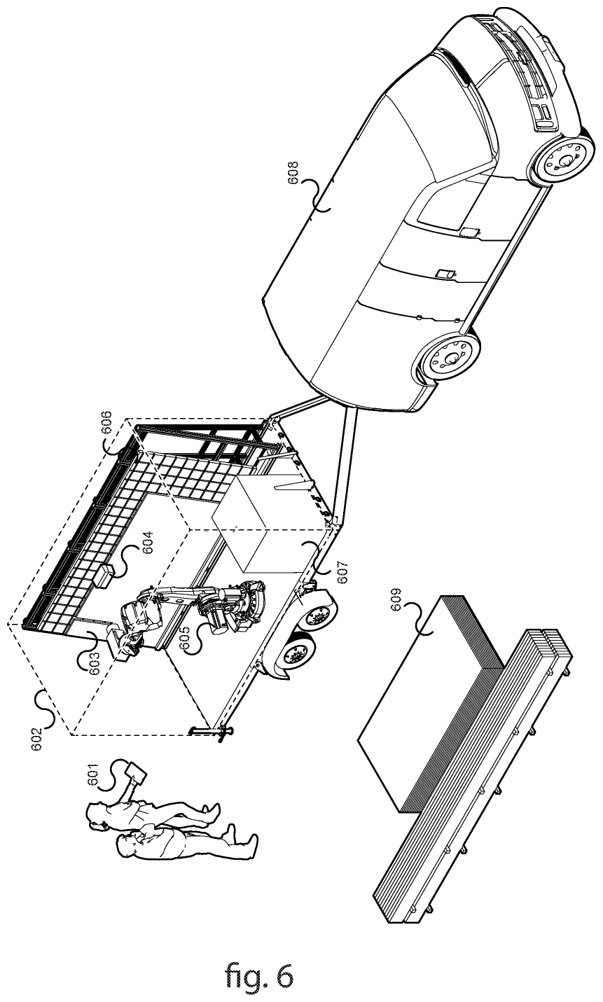

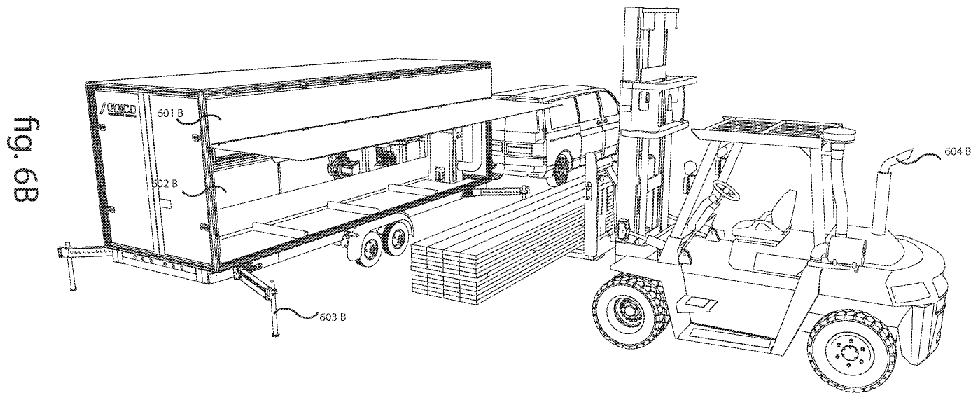

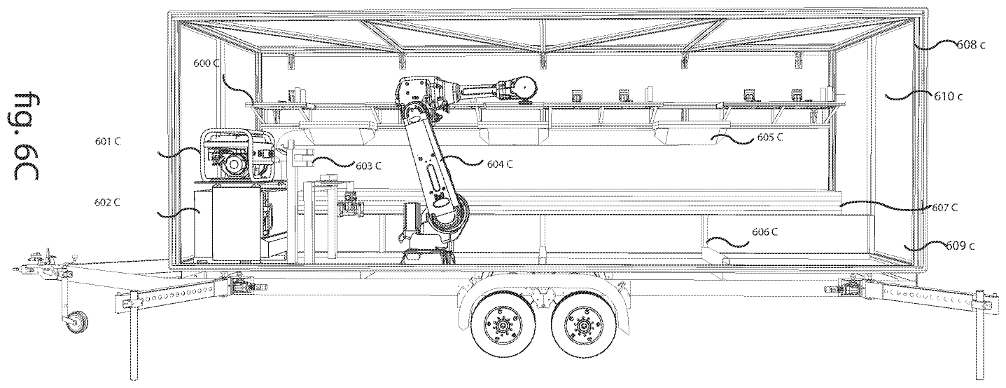

In FIG. 6a a computer-controlled fabrication system positioned in a trailer 602 pulled by a car/van 608 is shown.

A user has made a hand-drawn notation on a workpiece 603. The workpiece is positioned in the trailer on or in a worktable 606 in such a way that a camera 604 has been able to capture an image of at least that part of the workpiece 603 that has the hand-drawn notation and will be machined. The image has been sent from the camera 604 to a robotic controller or server 607, where the captured image has been processed so that the image could be presented on a tablet UI 601 and instruct a robotic manipulator 605 how to machine the workpiece 603. The user has approved interpretation of the hand-drawn notation and how to machine the workpiece 603, and instructions have been sent from the controller or server 607 to the robotic manipulator 605 how to machine the workpiece 603. As shown, the robotic manipulator 605 is machining the workpiece 603 at the very moment.

Next to the trailer 602, there is further material 609 to process.

In FIG. 6b, another embodiment of the computer-controlled fabrication system is shown, where the computer-controlled fabrication system is framed within a trailer 601b, which can be attached and pulled by an ordinary car or a light truck having a tow bar. Further, the system may be devised to hold an opening 602b along the whole length of the trailer for loading construction materials means of a forklift 604b or related manual loading methods. The trailer according to any embodiment may have support legs 603b for supporting the trailer. When the trailer rests on the support legs instead of on the springs of the trailer, the trailer will be prevented from moving during loading process. The loading process will be easier.

In FIG. 6c, another embodiment of the trailer 608c with the computer-controlled fabrication system is shown. This embodiment of the associated production system may further be configured such that it entails a 6-axis industrial manipulator 604c, an onboard power supplying device 601c, such as a generator or battery supply; and a control device 602c for the industrial manipulator. Further, the configuration may entail a bed 606c from which loaded material 607c can be picked. A tool changing device 603c enables the manipulator to interchangeably switch between 2 or more end-effectors. And finally, the embodiment may entail a longitudinal external axis 600c, on which timber beams can be placed and shifted forwards and backwards in position along the axis 600c. Openings 609c in short sides 610c of the trailer allow even a board or a beam (not shown) on top of the external axis 600c to be moved by the external axis 600c without being limited by the short sides. Collectors 605c will collect machined material like e.g. saw dust from the machining process so that the interior of the trailer stays clean. A vacuum pump (not shown) can be connected to the collectors for sucking the machined material so that the collectors are not overfilled.

The totality of this embodiment as such allow for a process, in which a) a material stack is loaded unto the station; b) a sensor device mounted on the manipulator or in the structural frame detects the position and dimension of the loaded material stack; c) the manipulator—using a robotic gripper—picks one timber item from the stack and positions the timber item in the external axis; d) the manipulator changes to a machining end-effector such as milling spindle or saw; e) the external axis moves the timber item back and forth on the external axis to achieve a desired position, which enables the manipulator to machine the timber item within the confinement of the trailer frame; f) processed pieces are—after a second tool change—picked by the manipulator and placed in a second stack of processed elements, which are positioned within reach of a second opening inside the trailer; g) the processed elements are picked by a forklift or similar device for use in construction.

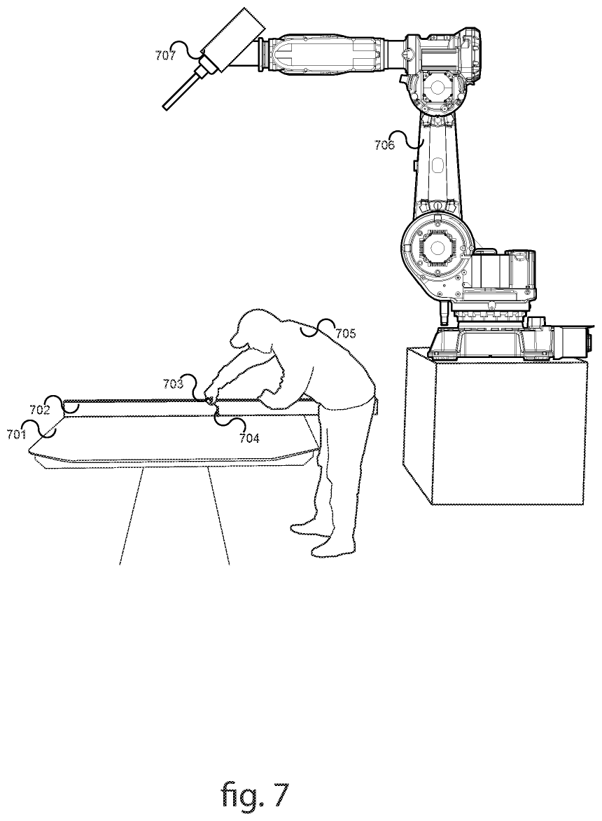

A rotatable worktable 701 is shown in FIG. 7, on which a workpiece 702 is resting. A user 705 is handdrawing a sign 704 on the workpiece 702 using a pen 703. A robotic manipulator 706 with a tool 707 attached is positioned behind the user 705 ready to receive instructions to machine the workpiece 702.

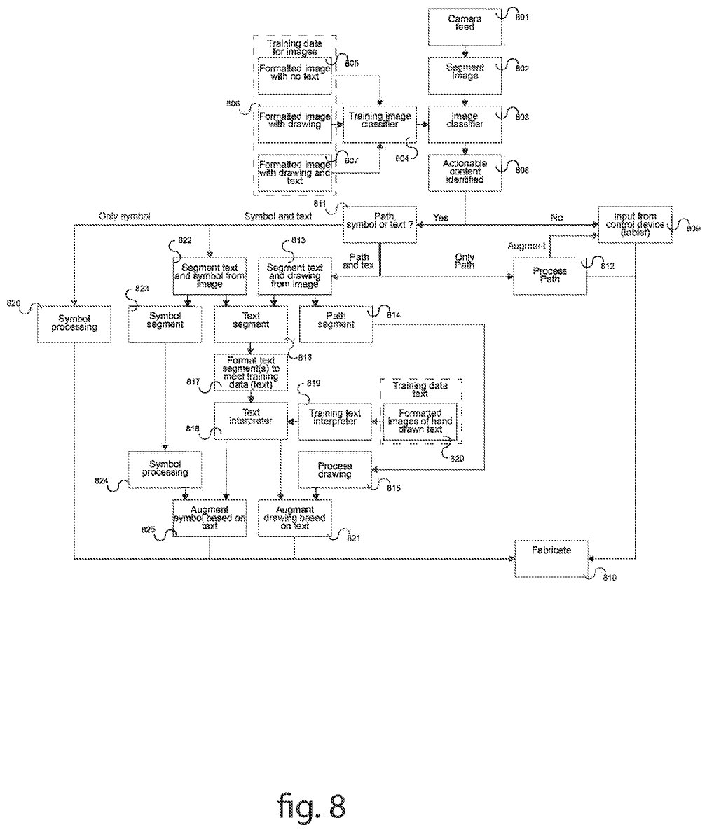

FIG. 8 shows in a flowchart diagram, how the step of the computer-implemented interpretation 104 in FIG. 1 of hand-drawn symbols on the work-piece, may be processed in detail.

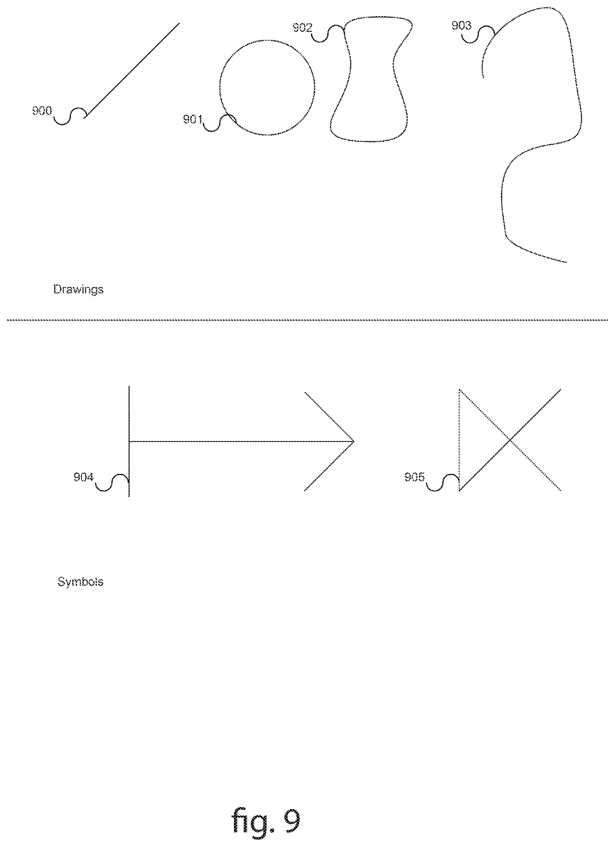

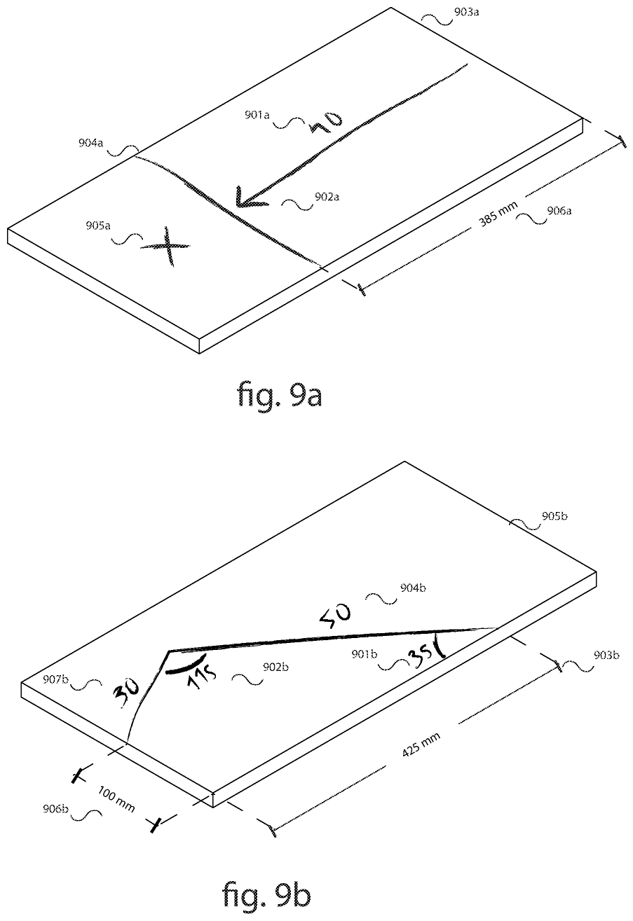

In a first step, a camera input from a camera is received in the form of a video or images 801. The images are segmented 802 and the segments are formatted against a group of pre-determined image classifier standards 803. The classification is executed using an instance of an Artificial Intelligent (AI) system 804-807, which is pre-trained to detect either text, symbols, paths (see FIG. 9) or a combination thereof within an image. This type of classification using an AI system is a standard procedure and well-known in the art, see e.g. Pattern Recognition and Machine Learning, Christopher Bishop, Springer, 2006; Machine Learning for Text, Charu C. Aggarwal, Springer, 2018; and Understanding Machine Learning: From Theory to Algorithms, Shai Ben-David and Shai Shalev-Shwartz, Cambridge University Press, 2014.

Upon analysis, the AI system will return a value to denote if actionable content was detected in the camera input 808. In case no actionable content is detected, the system will prompt the user and await input through the display unit 809. In case actionable content is detected, an Action Identifier 811 determines the further process against the classification of the found content (path, text, symbol or combinations thereof).

In case of detecting paths only 812, the information may be processed according preceding steps 401-417 in FIG. 4. For combinations of paths and texts 813, the path and text objects are segmented from one another. The path segment 814 is processed in process drawing 815 according to the steps 401-417 of preceding FIG. 4.

The isolated text segment 816 is formatted against the requirements of the text interpreter 817. The text interpreter 818 represents a second AI system, which may rely on multi-classification or convolutional neural nets to classify individual, hand-written letters. The text interpreter may be trained 819 against formatted training data 820, e.g. the MNIST library or similar databases.

In a further step 821, the processed texts and paths are analysed in combination, and the spatial relation between individual path segments and individual text objects is determined. By measuring the distances from any given point on a path segment to the area centroid of a text object, pairs are created between text and path segments. Upon determining pairs, the text object is screened for numerical content according to any number system.

Upon determining a numeric value, the value will be assumed to represent dimensional information for the path segment, provided by the user. The interpreted dimension information is measured against the real-world measures of hand-drawn elements on the work-piece. In case of discrepancies,—such as e.g. the dimensional information stating 45 cm in real units, and the measured length of a segment being registered as 43.7 cm—the interpretation module adjusts the interpreted length of the path segment (43.7) to the identified dimensional value read from the text object (45 cm) and prompt the user through the display port for acceptance or correction of the interpretation.

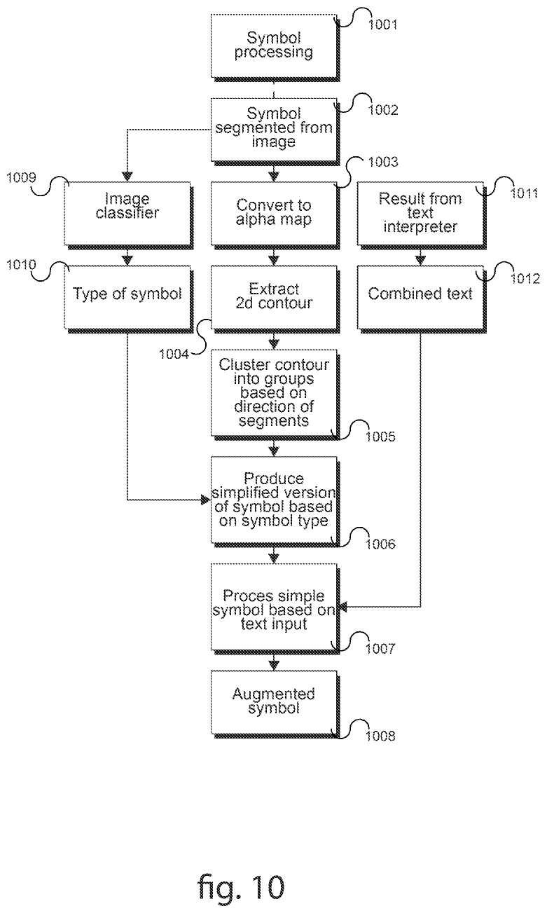

In case of identifying the presence of both symbols and text in the drawn content 822, text and symbols are separated and text elements are processed according to steps 816-818. The isolated symbol 823 is processed to generate a numeric instance of the symbol 824. This instance may be achieved according to the steps outlined in FIG. 10. In a further step 825, the numeric instance of the symbol may be augmented against text data found in the text interpretation process. This could entail situations such as augmenting the length of an arrow or diameter of a circle based on dimensional information given in text form. In case of identifying only symbolic image content 826, the symbol is processed according to step 824.

As stated in preceding descriptions, one instance of the disclosed method (FIG. 1), may be to identify image content according to three classes: a) paths; b) text; and c) symbols. Paths are considered any instance of open or closed curves, drawn by the user on the workpiece. An open curve denotes a curve, in which the starting point and end point of the curve are not coinciding. This may take the form of straight lines 900 or curved lines 903, as shown in FIG. 9.

Closed curves denote any curve, in which the start point and end point are coinciding. These may be distinguished in closed curves, which can be conformed to geometric primitives, such as circles, ellipsoids, triangles, rectangles and other polygons 901; or arbitrary closed curves that does not conform to known geometric primitives 902.

In the context of the present disclosure, the utility of paths is considered the interpretation of user hand-drawn curves to designate a desired toolpath for a machining process, e.g. a straight line to be followed by a digitally controlled saw to perform a cut; or a curve to be followed by a digitally controlled point-tool to machine any arbitrary shape.

Image content in the form of text, denote any numeral system used to indicate numeric information hand drawn on the workpiece by the user. Or it may denote any elements of an alphabetic system used to supply additional information, such as part numbering or units of measurement. In the context of the present disclosure, the utility of texts is for the user to—by hand-writing on the work-piece—provide supplementary information to a hand-drawn notation. This could be in the form of e.g. stating in numeric form a desired dimension of a line; a desired angle of a line; or a desired diameter of a circle, etc.

Image content in the form of symbols denote any recognizable combination of curve segments that through digital processes can be abstracted to generic symbols; or system specific symbols stored in a library. In terms of generic symbols, this could be in the form of dimensional arrows or dimension lines 904; cross-markings 905; or angled lines denoting perpendicularity. In the context of the present disclosure, the utility of symbols is to enable the user through hand-drawing thereof to instruct a machining system with specific, pre-determined commands that are associated to other drawn content.

FIG. 9a shows how a use scenario of the disclosed method, pertaining to the preceding descriptions, can be exemplified. A workpiece—consisting of a rectangular piece of hardwood—needs to be cut so that the length of the piece after the cut is 400 mm.

To instruct the digital production system through hand-drawing, the user performs the following notations on the workpiece: first, a cutting line is drawn 904a. The cutting line is drawn per eye-measure of the user at the approximate location of the cut. Through the steps disclosed in preceding descriptions, the cutting line is recognized as a path-object in the form of an open curve, representing an approximation of a straight line. The line is conformed to an exact straight line, and the location of its start point is measured to 385 mm 906a from an edge 903a of the workpiece.

In addition to the cutting line, the user has further drawn a cross-mark 905a; an arrow 902a; and the digits “40” 901a. According to preceding procedures, the cross-mark and arrow are identified as symbols, recognizable within an associated library and denoting a pre-determined instruction. The cross-mark denotes an instruction that the area delimited by the cutting line be considered the cut-off. Hereby, the system is implicitly instructed to position the saw-blade such that the width of the saw-blade is subtracted from the cut-off piece. Further, the arrow is recognized as a dimension instruction, designating the value “40”. By associating the dimension instruction to the cut-line position, the system infers that while the measured position of the line is 385 mm, the instructed distance is “40”. By proportionally relating “40” to the physical measures of the workpiece, the system will infer that the implied units of the dimension instructions are centimetres, and thus the instructed dimension target is 400 mm. following these steps, the system will prompt the user of the result of its interpretation, and query the users acceptance or adjustment of the interpreted instructions, and await a signal for execution.

FIG. 9b shows how in another use scenario, the user has performed a hand-drawn notation on a workpiece 905b. The content is identified as: four curves—two linear and two curved; and the numbers 30, 50, 115 and 135. Through the drawing interpretation steps outlined in the preceding descriptions, the system infers the following information: two straight lines are identified as paths with associated text, denoting dimension instructions 904b and 907b; two curved segments are identified as angle demarcations with associated angle values 901b, 902b.

The interpreted content is thus two straight cut lines, with an interior angle of 115 degrees, meeting the boundary of the workpiece at an angle of 35 degrees. The measured start point of the cutting lines are respectively placed 100 mm 906b and 425 mm 903b from the shared corner within the area delimited by the cutting lines. This interpretation is prompted to the user for acceptance or editing, upon which execution may be initiated.

In FIG. 10 an embodiment of the present disclosure is shown, where the method of symbol processing denoted in FIG. 8, (steps 823-826) may entail the following steps: at the initiation of the symbol processing 1001, the symbol is segmented from the image content 1002, and the segmented image is converted to an alpha map 1003. Supplementary, an image classifier 1009 is used to determine the recognized type of symbol against an electronic library of available symbols, which the system is trained to detect, 1010. Parallel, 2D contours of the image are extracted 1004. In a further step, contours are clustered into subgroup according to their direction within the image space 1005. Based on this information an abstracted, numeric instance of the symbol is obtained 1006.

By distance association of the area centroid of a text group against closest points of any lines of the symbol, numeric values from hand-written texts of the text interpreter 1011, 1012 are attributed to the symbol 1007. Hereby, an augmented instance of the symbol is achieved 1008, in which an implied machining instruction is achieved.

1. A method for manufacturing construction components at a building site, the method comprising the steps of
loading a material stack to be manufactured onto a bed of a transportable frame or next to the transportable frame, wherein the transportable frame carries an industrial manipulator and an external axis,
transferring by the industrial manipulator a piece of the loaded material stack onto the external axis,
moving the transferred piece by the external axis for allowing a desired position of the piece to be manufactured by the manipulator,
manufacturing the transferred piece by the manipulator into a manufactured construction component, and
transferring the manufactured construction component to a second stack of manufactured construction components.

2. The method according to claim 1, wherein the material stack comprises uni-directionally elongated pieces, such as boards, pipes or rods

3. The method according to claim 1 or 2, wherein the transportable frame comprises a cover, wherein the material stack or the piece of the material stack is loadable/transferrable through an opening in the cover.

4. The method according to claim 3, wherein the cover comprises a longer side and a shorter side and the opening stretches along the longer side.

5. The method according to any of the preceding claims, wherein
the manipulator changes manipulation heads between the steps of transferring the piece onto the external axis and of manufacturing the transferred piece,
the manipulator comprises simultaneously the manipulation heads for transferring the piece onto the external axis and for manufacturing the transferred piece, or
the manipulator for transferring the piece onto the external axis and the manipulator for manufacturing the transferred piece are two different manipulator.

6. The method according to any of the preceding claims, wherein the method comprises the step of receiving data about final length of at least one of the manufactured construction components and/or angle of machining.

7. The method according to any of the preceding claims, wherein length and/or width and/or thickness of the piece to be manufactured and/or of the manufactured construction component is/are determined.

8. The method according to any of the preceding claims, wherein the manipulator and/or the external axis is/are controlled by a mobile computing device.

9. The method according to any of the preceding claims, wherein each component in a series of manufactured construction components is at least partly uniquely labelled.

10. A portable manufacturing unit for manufacturing construction components, the manufacturing unit comprising
a bed configured for receiving a material stack to be manufactured,
an external axis,
an industrial manipulator configured for transferring a piece of the material stack to the external axis,
wherein the external axis is configured for moving the transferred piece on top of the external axis for allowing a desired position of the piece to be manufactured by the manipulator, wherein the manipulator is further configured for manufacturing the moved piece into a manufactured construction component, and wherein the external axis or the manipulator is configured for transferring the manufactured construction component to a second stack of manufactured components.

11. The portable manufacturing unit according to claim 10, wherein the manufacturing unit has a longer side and a shorter side, and the manufacturing unit comprises a cover covering the manufacturing unit, wherein the cover has a first opening along the longer side configured for receiving the material stack and/or the piece of the material stack.

12. The portable manufacturing unit according to claim 10 or 11, wherein the manufacturing unit has a longer side and a shorter side, and the manufacturing unit comprises a cover covering the manufacturing unit, wherein the cover has a second opening in the shorter side, wherein the second opening is positioned for allowing at least an end of the transferred piece on top of the external axis to be moved past the cover.

13. The portable manufacturing unit according to any of the claims 10-12, wherein
the manipulator changes manipulation heads between the steps of transferring the piece onto the external axis and of manufacturing the transferred piece,
the manipulator comprises simultaneously the manipulation heads for transferring the piece onto the external axis and for manufacturing the transferred piece, or
the manipulator for transferring the piece onto the external axis and the manipulator for manufacturing the transferred piece are two different manipulator.

14. The portable manufacturing unit according to any of the preceding claims 10-13, wherein the portable manufacturing unit is controlled by a mobile computing device.

15. The portable manufacturing unit according to any of the preceding claims 10-14, wherein the portable manufacturing unit comprises a sensor configured for determining length and/or width and/or thickness of the piece to be manufactured and/or of the manufactured construction component.

16. The portable manufacturing unit according to any of the preceding claims 10-15, wherein the portable manufacturing unit comprises a labelling machine configured for labelling the manufactured construction components at least partly uniquely.

17. A software application executable on a machine tool system for machining a workpiece, wherein the software application is configured for executing the steps of:
instructing an image recording device to capture an image of a first workpiece having one or more hand-drawn notations,
associating the one or more notations with at least one machining step of the machine tool system,
presenting on a display device
the at least one machining step of the machine tool system on or in relation to the captured image, and/or
the first workpiece as the first workpiece will appear after machining the first workpiece according to the at least one machining step of the machine tool system, and
optionally controlling a tool of the machine tool system for machining the first workpiece according to the one or more notations.

18. The software application according to claim 17, wherein the software application is configured for executing the steps of presenting on the display device
a distance from a first point on the first workpiece to a second point on the first workpiece, where the machining step will be machining the first workpiece according to the one or more notations, and/or
an angle between a first direction of the first workpiece and a second direction of the first workpiece, in which the machining step will be machining the first workpiece according to the one or more notations.

19. The software application according to claim 17 or 18, wherein the display device is an electronic screen, augmented reality glasses, virtual reality glasses, a hologram illuminated by light, and/or a brain-computer interface.

20. The software application according to any of the preceding claims 17-19, wherein the software application is configured for executing the steps of:
presenting on the display device the option of either including or excluding the one or more hand-drawn notations in the part of the first workpiece that is removed when machining the first workpiece.

21. The software application according to any of the preceding claims 17-20, wherein the image recording device is a camera, preferably a digital camera like a CCD camera or a camera with an active-pixel-sensor like e.g. a CMOS sensor.

22. The software application according to any of the preceding claims 17-21, wherein the software application is configured for executing the steps of:
presenting on the display device different types of connections between the first workpiece and a second workpiece,
receiving instruction about the type of connection to connect the first workpiece and the second workpiece, and
optionally controlling the tool of the machine tool system for machining the first workpiece according to the one or more notations and according to the type of connection to connect the first workpiece and the second workpiece, and
optionally controlling the tool of the machine tool system for machining the second workpiece according to the one or more notations and according to the type of connection to connect the first workpiece and the second workpiece.

23. The software application according to any of the preceding claims 17-22, wherein the software application is configured for executing the step of determining for each of the one or more hand-drawn notations whether the one or more hand-drawn notations is/are
a straight or curved line,
a number and/or one or more letters,
a symbol, or
a combination thereof.

24. The software application according to claim 23, wherein the symbol is a first symbol, e.g. an arrow, for indicating a length, or a second symbol, e.g. a circular arc, for indicating an angle.

25. The software application according to claim 23 or 24, wherein the software application is configured for executing the step of associating a first hand-drawn notation determined to be a number with a second hand-drawn notation determined to be
a straight or curved line, or
a symbol.

26. The software application according to claim 25, wherein the second hand-drawn notation is a straight or curved line, and wherein if the position of the machining step according to the second hand-drawn notation does not coincide with the machining step according to the number, the software application is configured for executing the step of interpreting the machining step indicated by the second hand-drawn notation to be in accordance with the number.

27. The software application according to any of the preceding claims 17-26, wherein the software application is configured for interpreting a hand-drawn notation within the content of a recorded image in order to extract from the hand-drawn notation a number, and for manipulating a location of a line in the captured image based on the number.

28. A machine tool system for machining a workpiece, wherein the machine tool system is configured to be controlled by the software application according to any of the preceding claims 17-27.

29. The machine tool system according to claim 28, wherein the machine tool system comprises an image recording device positioned on a joint arm.

30. The machine tool system according to claim 28 or 29, wherein the machine tool system is integrated in the portable manufacturing unit according to claim 10-16.

31. A method of machining a workpiece using a tool of a machine tool system comprising the steps of
handdrawing one or more hand-drawn notations on a first workpiece, capturing an image of the first workpiece having the one or more hand-drawn notations using an image recording device,
associating the one or more hand-drawn notations with at least one machining step of the machine tool system,
controlling a tool of the machine tool system for machining the first workpiece according to the one or more notations.

32. The method according to claim 31, wherein the method further comprises any of the steps of claims 1-9.
